(19) United States
(12) Patent Application Publication
(10) Pub. No.: US 2003/0060958 A1
(43) Pub. Date: Mar. 27, 2003

(54) PROCESS FOR EVALUATING A ROAD LAYOUT FOR AN AUTOMATIC GEARBOX

(76) Inventors: MARKUS HENNEKEN, KRESSBRONN (DE); WOLFGANG SCHMID, LANGENARGEN (DE); MARKO POLJANSEK, REUTLINGEN (DE)

Correspondence Address: DAVIS & BUJOLD, 500 N COMMERCIAL STREET, FOURTH FLOOR, MANCHESTER, NH, 03101

(21) Appl. No.: 09/180,518

(22) PCT Filed: May 7, 1997
(86) PCT No.: PCT/EP97/02317

(30) Foreign Application Priority Data
May 10, 1996 (DE) 196 18 804.0

(51) Int. Cl. F16H 61/62

(52) U.S. Cl. 701/51; 477/120

(57) ABSTRACT

The invention relates to a process for evaluating a road layout for an automatic vehicle gearbox. Said process has the following stages: 1) determination of transverse acceleration (a_Quer) of the vehicle on the basis of measured wheel speeds (n_Rad) for the purpose of evaluating bends; 2) testing to check whether a first cornering process has occurred, and if it has, starting of a predetermined period (T) in a processing operation (S3); 3) a theoretical driver-type value (FT_Soll) and a first increment (INKR_O) between said theoretical value and an actual driver-type value (FT_Ist) on the basis of the vehicle transverse acceleration (a_Quer) and a vehicle speed (v_F); 4) in a differentiating operation (S6), to determine whether a second cornering process is occurring during the predetermined period (T), testing to check whether the period (T) has finished, and if it has not, a processing operation (S8) is activated to determine a second increment (INKR) which is weighted in relation to the first increment (INKR_O) with a factor (A) related to a completed period of the predetermined period (T); 5) determination, on the basis of the second increment (INKR), of a gear-change characteristic (SL) from a plurality of characteristics each associated with a particular driver type.

The invention relates to a process for evaluating a road layout in an automatic transmission of a vehicle by means of a transmission control device having a calculation unit, a micro-controller, a memory device and a control device for start-up of a hydraulic transmission control device.

So-called “intelligent” gear change programs for electro-hydraulically controlled automatic transmissions of passenger cars are known.

Such an intelligent gear change program has been descibed, for example, in DE-OS 39 22 051 wherein by “intelligent” is understood that the driver of a vehicle need not to actuate any selector button for setting a specific gear change range such as for sporting drive or economic drive, since an electronic transmission control device infers from input variables the behavior of the driver and thus the type of driver. As input variables serve here, for example, the signal of a throttle valve, the speed of an internal combustion engine and the longitudinal and cross acceleration determined from the wheel speeds. According to the prior art, a driving activity or a type of driver is determined from input variables. Based on the driver type, an associate gear change program is then selected from a plurality of gear change programs. Thus, for example, for a slow driver type a gear change program with low changing points is selected and for a sporting driver type a gear change program with high changing points.

Since the driving behavior of a driver can be different in different driving situations, an otherwise sporting driver, for example, would nonetheless prefer a slower drive in certain driving situations and would find inappropriate in these situations a general classification of his driving behavior as sporting. The gear change program must therefore be able to react flexibly to different driving situations. Such a driving situation is the number of curves driven through.

In German patent 41 20 603 has been disclosed a process relative to a cornering in which an upshift is admitted only when the cross acceleration is below a limit value.

This process known from the prior art thus has the disadvantage of not evaluating in cornering the manner in which a curve is driven through or how curved the road layout is.

Therefore, the problem to be solved by this invention is to provide a process in which a driver type or the driving activity is evaluated in accordance with the curves driven through.

On the basis of the preamble of claim 1 this problem is solved by the steps stated in the characteristic part of claim 1.

The process according to the invention has the advantage that in a simple manner the kind of road layout is included in the evaluation of a driver type. Thereby it is advantageously possible that the actual driver-type value be repeatedly updated.

Other advantages of the invention result from the sub-claims and the description of the invention that follows and has reference to the basic drawing in which:

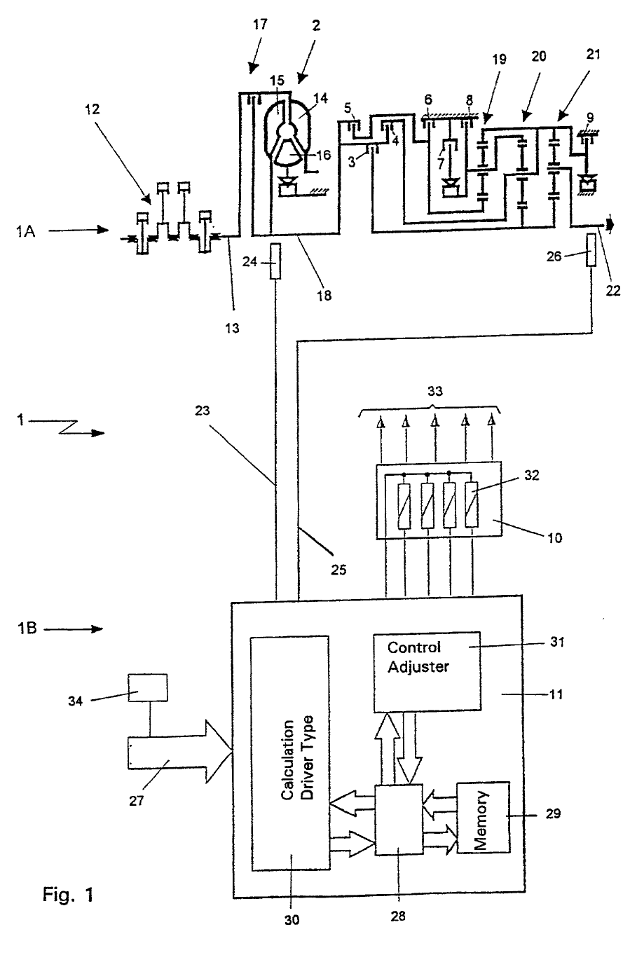

FIG. 1 is an extensively schematized system diagram of an automatic transmission;

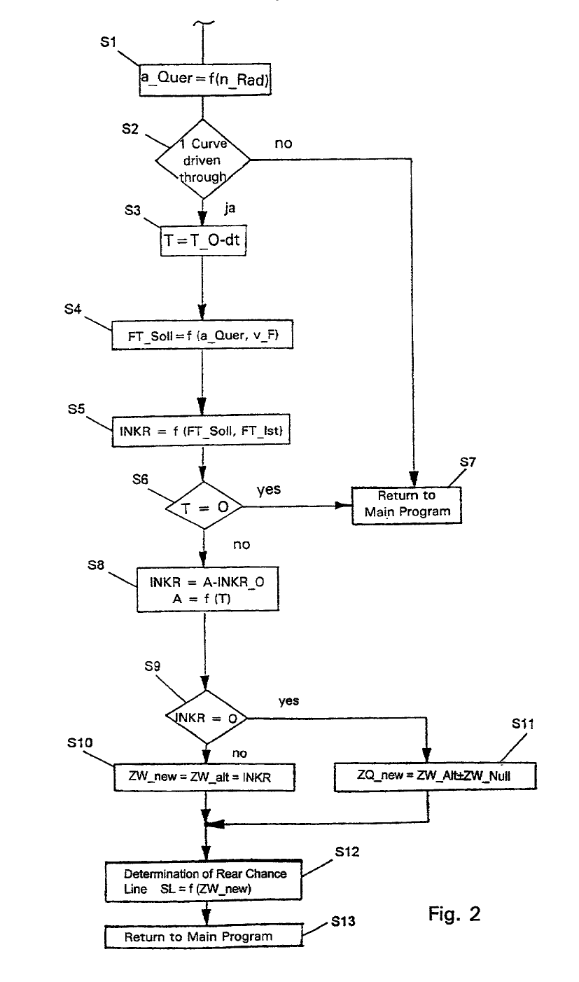

FIG. 2 is a program sequence for evaluating a road layout;

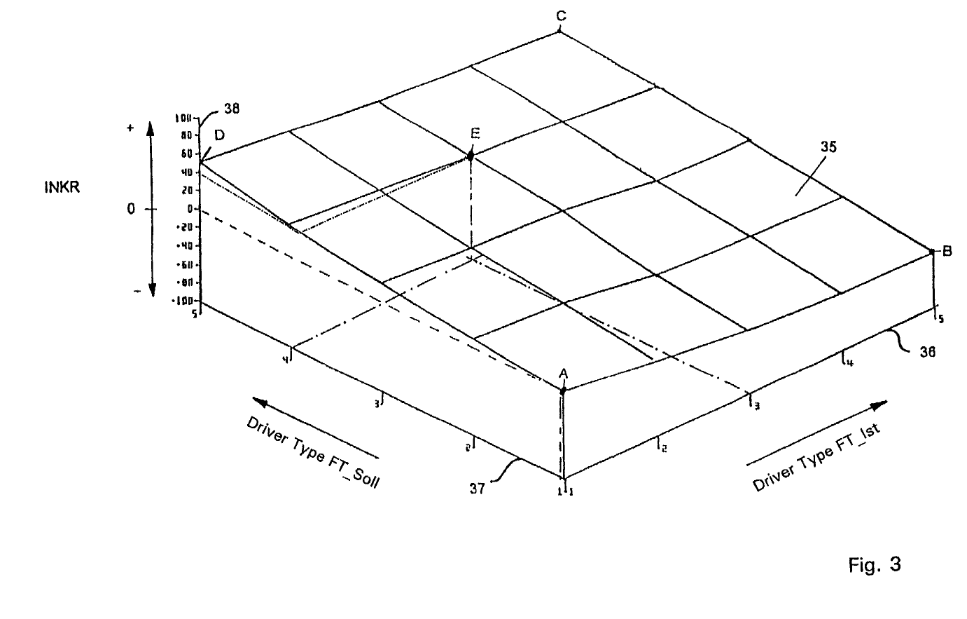

FIG. 3 is a performance graph to determine an increment (INKR_O); and

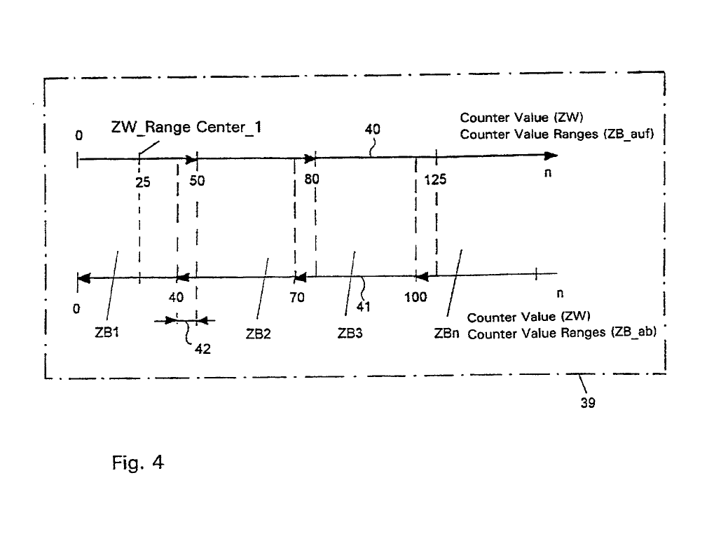

FIG. 4 is a diagrammatic representation of a counter.

FIG. 1, is an extensively schematized system diagram of an automatic transmission 1. The automatic transmission 1 consists of a mechanical part 1A having a hydrodynamic converter 2 and switching components 3 to 9 designed as clutches and brakes and a control part 1B having a hydraulic control device 10 and an electronic control device 11. The automatic transmission 1 is driven via an input shaft 13 by an input unit 12, conveniently an internal combustion engine. The input shaft 13 is non-rotatably connected with an impeller 14 of the hydrodynamic converter 2 which in addition has a turbine wheel 15 and a stator 16. Parallel to the hydrodynamic converter 2 is situated a converter clutch 17. The converter clutch 17 and the turbine wheel 15 lead to a turbine shaft 18, said turbine shaft 18 having, while the converter clutch 17 is actuated, the same speed as the input shaft 13. Together with the hydrodynamic converter 2 and the clutches and brakes 3 to 9, the mechanical part 1A of the automatic transmission 1 has two free wheels not specifically designated and three planetary gear sets 19,20 and 21 disposed in succession. In the automatic transmission 1, a transmission output shaft 22 leads to a differential, not shown, which drives via two axle half-shafts—also not shown-drive wheels of a vehicle. A gear step is selected via an appropriate brake/clutch combination. Since the components of the automatic transmission 1 are of no further significance for better understanding of the invention, they will not be discussed in detail at this point.

From the mechanical part 1A of the automatic transmission 1 to the electronic control device 11 is a line 23 for transmitting a turbine speed a signal produced by a measuring device 24 from the turbine shaft 18, and a line 25 for transmitting a transmission output signal produced by a measuring device 26 from the transmission output shaft 22. Together with the transmission output speed signal and the turbine speed signal, an engine control device 27, which controls the internal combustion engine 12 is symbolically indicated in FIG. 1 and transmits to the electronic control device 11 added input variables such as the signal of a throttle valve, the signal of the torque M_M generated by the internal combustion engine 12, the speed n_M of the internal combustion engine 12, temperature of the engine and of the hydraulic fluid of the automatic transmission 1, wheel speeds n_Rad. In accordance with said input variables the electronic control device 11 selects via the hydraulic control device 10 an appropriate gear step.

The electronic control device 11, which extensively schematized is shown in FIG. 1, has for this purpose a micro-controller 28, a memory device 29, a calculation unit 30, for determining the driver type, and a control device 31. The data relevant for the transmission which include, for example, program and data, such as diagnosis data, are deposited here in the memory device 29 which is conveniently an Eprom, EEProm, or as buffered RAM. The control device 31 serves automatically to start up control valves 32 which are in the hydraulic control device 10 and are provided for operating the clutches and brakes 3 to 9, as symbolically indicated by the arrow 33 in FIG. 1.

FIG. 2 shows a program sequence plan for a sub-program for evaluation of a cornering. To begin, a wheel speed n_Rad determined by a measuring device 34 is issued to a first processing function S1 of the calculation unit 30 for determining a driver type. The processing function S1 delivers by a calculation from the wheel speeds n_Rad a cross acceleration a_Quer of the vehicle. In a subsequent differentiation function S2 is tested whether a first curve has been driven through. If this is not the case the program branches for return to a main program to a processing function S7. But if a curve has been driven through, the differentiation function S2 activates a processing function S3 where, after abandoning the first driven through curve, a predefined time T is started. The time T is a time step which is formed in a manner such that from an initial value T_O is removed a time amount dt of a current time t. Mathematically considered the predefined time T thus constitutes a difference of an initial value T_O minus the time amount.

In another processing function S4 a driver-type theoretical value FT_Soll is determined from the vehicle cross acceleration a_Quer and a vehicle speed v_F. The vehicle speed v_F is here determined by a calculation unit 30 from a transmission output speed n_AB measured on the input shaft 22 of the automatic transmission 1. In a subsequent processing function S5, a first increment INKR_O is determined by a comparison of the driver-type theoretical value FT_Soll with a driver-type actual value FT_Ist.

FIG. 3 shows a preset performance graph 35 which determines the relationship between the driver-type theoretical value FT_Soil, the driver-type actual value FT_Ist and the first increment INKR_O, and serves to determine the increment INKR_O in the processing function S5. Here the driver-type actual value FT_Ist is plotted on a first axis 36, the driver-type theoretical value FT_Soll on a second axis 37 and the increment INKR on a third axis 38. In the performance graph 35 is a surface with the terminal points A, B, C and D.

To determine the increment INKR_O, the driver-type theoretical value FT_Soll and the driver-type actual value FT_Ist are first determined. The appertaining increment INKR_O results on the axis 38 from the intersection point of said two values in the performance graph 35.

Two examples can be seen in FIG. 3 for determining an increment INKR_O, the first example being shown in hatched lines and the second example in dash-dot lines.

In the first example the driver-type theoretical value FT_Soll is determined with the value one and the driver-type actual value F_Ist also with the value one. As intersection point results the joint A with which is associated the value zero of the increment INKR_O.

In the second example are plotted a driver-type theoretical value FT_Soil of four and a driver-type actual value FT_Ist of three. Therefrom results in the performance graph 35 an intersection point E with which is associated on the axis 38 the value 40 of the increment INKR_O.

After determining the first increment INKR_O, in a differentiation function S6 is tested whether the time T is now equal to the value O, since the differentiation function 6 (?) thereby detects that the time T has expired, that is, that the time step has reached the end value of O. When the time T has expired this means that in the time T no other curve has been driven through. The differentiation function S6 activates in this case the processing function S7 for return to the main program. But if the time T is not equal to the zero value, which means that the time step still has not reached the end value of O, for additional evaluation of the first increment INKR_O determined from the first cornering, another processing function S8 is activated in which for determining a second increment INKR, the first increment INKR_O is weighted with a factor A dependent on the expired time of the predefined time T. Mathematically considered the increment INKR thus constitutes a product of the first increment INKR_O and the factor A. The value of the second increment approximates by so much the value of the first increment INKR_O the longer the time T has already run. If the time T has expired 100%, the first increment INKR_O is taken into account up to 100%, since the factor A corresponds to the value 1.

In a differentiation function S9 is now tested whether the second increment INKR is equal to the zero value.

According to the result delivered by the differentiation function S9, a counter 39 shown in FIG. 4 is set with the counter values ZW which are subdivided in counter value ranges ZB associated with a certain driver type or cornering style. The counter 39 has a high counter 40 and a low counter 41 which are symbolically shown as numeric unlimited lines running parallel to each other. The high counter 40 begins with the value zero and rises continuously up to a counter value ZW, of n, and the low counter 41 extending in opposite direction begins with the counter value of n and descends continuously down to the counter value of zero. The intervals between the counter values ZW are identical in the high counter 40 and in the low counter 41 so that the counter values of the high counter 40 and of the low counter 41 overlap. The counter values are divided in n-counter value ranges wherein the intervals of a counter value range ZB-auf in the high counter 40 and those of a counter value range ZB-ab in the low counter 41 coincide. But the counter value ranges ZB-auf and ZB-ab are offset relative each other by a certain number of counter values ZW, ten counter values in the example of FIG. 4. According to FIG. 4 the first counter value range ZB_auf_{—}1 of the high counter 40 begins with the counter count zero and ends at the counter value 50. The second counter value range ZB_auf_{—}2 of the high counter 40 begins at the counter value 50 and ends at the counter value 80. On the other hand, in the instant example, the counter value range ZB_ab_{—}1 of the low counter 41 begins with the counter value 40 and ends at the counter count zero. The second counter value range ZB_ab_{—}2 of the low counter 41 begins with the counter value 70 and ends with the counter value 40. The counter value ranges ZB_auf, ZB_ab represent sporting steps of a driver type or driving behavior wherein with the rising number of the counter value ranges ZB_auf and ZB_ab the sportiveness of the movement of a vehicle is rated higher. Between the correlating counter value ranges ZB_auf_n and ZB_ab_n there result in the limit range overlapping zones 42 due to the offsetting relative each other of the counter value ranges ZB_auf and ZB_ab. The width of an overlapping zone 42 corresponds to the counter value interval by which the counter value ranges have been offset relative each other, that is, the overlapping zone 42 in the example of FIG. 4 shows a width of ten counter values. The overlapping zones 42 represent here passive zones.

If the differentiation function S9 of FIG. 2 delivers the result that the increment INKR equals zero, that is, that the driver-type theoretical value FT_Soll and the driver-type actual value FT_Ist are identical, in a processing function S11 the new counter value is determined according to the equation ZW_Neu=ZW_Alt+−ZW_Null. This means that the counter ZW-Neu has been passed to the range center wherein the sign of the term ZW-Null gives therefrom whether the old counter value ZW_Alt is higher or lower than the range center.

By way of example for this, in FIG. 4 is plotted a counter value ZW_range center of the counter value ranges ZB_auf_{—}1 and ZB_ab_{—}1, the counter value of which amounts to 25.

If the result given by the differentiation function S9 is that the increment is higher or lower than zero, that is, that the driver-type theoretical value FT_Soll and the driver-type actual value FT_Ist differ from each other, in a processing function S10 an addend is determined as new counter value ZW_Neu from a preceding counter value ZW_Alt and the increment INKR and the counter 39 is set accordingly.

The counter 39 thus is increased or decreased directly without filtering in accordance with the driving situation or set to the center of a counter value range in case of coincidence of driver-type actual value FT_Ist and driver-type theoretical value FT_Soil.

In a processing function S12, with the new counter value ZW_Neu is associated a gear change line SL from a plurality of gear change lines, each of which is suited to a certain driver type in accordance with the road layout or cornering style and a gear change line having high or low gear change points according to the driver type is selected via the increment INKR.

Thereafter the main program is returned to via a processing function S13.

Reference numerals

| | |
|---|---|
| 1 | automatic transmission |
| 1A | mechanical part of the automatic |
| | transmission |
| 1B | control part of the automatic |
| | transmission |
| 2 | hydrodynamic converter |
| 3 | gear change component |
| 4 | gear change component |
| 5 | gear change component |
| 6 | gear change component |
| 7 | gear change component |
| 8 | gear change component |
| 9 | gear change component |
| 10 | hydraulic transmission control |
| | device |
| 11 | electronic transmission control |
| | device |
| 12 | input unit |
| 13 | input shaft |
| 15 | impeller |
| 15 | turbine wheel |
| 16 | stator |
| 17 | converter clutch |
| 18 | turbine shaft |
| 19 | first planetary gear set |
| 20 | second planetary gear set |
| 21 | third planetary gear set |
| 22 | transmission output shaft |
| 23 | turbine speed signal line |
| 24 | turbine speed measuring device |
| 25 | transmission output speed signal |
| | line |
| 26 | transmission output speed |
| | measuring device |
| 27 | engine control device |
| 28 | micro-controller |
| 29 | memory |
| 30 | calculation unit |
| 31 | control device |
| 32 | adjuster |
| 33 | pressure loading arrow |
| 34 | wheel speed measuring device |
| 35 | performance graph |
| 36 | first axis of the performance |
| | graph |
| 37 | second axis of the performance |
| | graph |
| 38 | third axis of the performance |
| | graph |
| 39 | counter |
| 40 | numeric unlimited line high |
| | counter |
| 41 | numeric unlimited line low |
| | counter |
| 42 | overlapping zone |

1. A process for evaluation of a road layout in an automatic transmission of a vehicle by means of an electronic transmission control device having a calculation unit, a micro-controller, a memory device and a control device for start-up of a hydraulic transmission control device, characterized by the following steps:
1. from wheel speeds (n_Rad) measured by a measuring device (34) on wheels of the vehicle, by the calculation unit (30) is determined a cross acceleration (a_Quer) of the vehicle for cornering,
2. in a differentiation function (S2) is tested whether a first curve has been driven through and in the affirmative a predefined time (T) is started in a processing function (S3),
3. from the vehicle cross acceleration (a_Quer) and a vehicle speed (v_F) are determined a driver-type theoretical value (FT_Soll) and a first increment (INKR_O) between the latter and a driver-type actual value (FT_Ist),
4. in a differentiation function (S6), for determining whether in the predefined time (T) one other curve has been driven through, it is tested whether the time (T) has expired and in the negative a processing function (S8) is activated to determine a second increment (INKR), which is weighted with a factor (A) dependent on an expired time of the predefined time (T) against first increment (INKR_O),
5. from the second increment (INKR) a gear change line (SL) is determined from several gear change lines each one associated with certain type of driver.

2. The process according to claim 1, characterized in that the predefined time (T) represents a time step reduced from an initial value (T_O) by an amount (dt).

3. The process according to claims 1 and 2, characterized in that the differentiation function (S6) detects the time (T) as having expired when the value of the time (T) equals a zero value.

4. The process according to any one of claims 1 to 3, characterized in that a processing function (S7) for return to the main program is started when in a differentiation function (S2) has been established that a first curve has not been driven through or when in the differentiation function (S6) has been established that the predefined time (T) has expired.

5. The process according to any one of claims 1 to 4, characterized in that the vehicle speed (v_F) is determined by the calculation unit (30) from a transmission output speed (n_AB) measured on a transmission output shaft (22).

6. The process according to any one of claims 1 to 5, characterized in that the first increment (INKR_O) is determined in a processing function (S5) from a preset performance graph (35) which determines the relationship between the driver-type theoretical value (FT_Soll), the driver-type actual value (FT_Ist) and the first increment (INKR_O).

7. The process according to any one of claims 1 to 6, characterized in that for determining the gear change line (SL) from the second increment (INKR)
1. the increment (INKR) is issued to a differentiation function (S9) to establish whether the increment (INKR) equals a zero value and in the affirmative a counter (39) is set with counter values (ZW) subdivided in defined counter value ranges (ZB_auf, ZB_ab) associated with a certain driver type or cornering style in a manner such that as new counter value (ZW_Neu) is determined according to the function ZW_Neu=ZW_Alt+−ZW_Null in a processing function (S11) and if the increment (INKR) is higher or lower than zero, an addend is determined as new counter value (ZW_Neu)from a preceding counter value (ZW_Alt) and the increment INKR),
2. in a processing function (S12) with the new counter value (ZW_Neu) is associated a gear change line (SL) and a processing function (S13) is started for return to the main program.

8. The process according to claim 7, characterized in that the counter value ranges (ZB_auf, ZB_ab) of the counter (39) have overlapping zones in their limit areas.
